(19) United States
(12) Patent Application Publication
(10) Pub. No.: US 2024/0262043 A1
(43) Pub. Date: Aug. 8, 2024

(54) LASER-INSCRIBED AND LASER-WELDED SHAPED BODIES AND PRODUCTION THEREOF

(71) Applicant: BASF SE, Ludwigshafen (DE)

(72) Inventor: Peter Eibeck, Ludwigshafen (DE)

(21) Appl. No.: 18/289,766

(22) PCT Filed: May 4, 2022
(86) PCT No.: PCT/EP22/62050

§ 371 Date: Nov. 7, 2023

(30) Foreign Application Priority Data
May 11, 2021 (EP) 21173280.5

(51) Int. Cl. B29C 65/16; B29K 67/00

(52) U.S. Cl. CPC B29C 65/1616; B29C 65/1635; B29C 2791/009; B29C 2795/007; B29K 2067/006; B29K 2995/0027

(57) ABSTRACT

The present invention relates to shaped bodies comprising at least a first molded part and a second molded part, where the first molded part is at least partly transparent to NIR radiation, the second molded part absorbs NIR radiation such that the first molded part and the second molded part are at least partly joined to one another by laser transmission welding, where the first molded part has at least one subregion which is dark-colored and where at least a portion of the subregion has a light-colored laser inscription, where the first molded part consists at least partly of a molding compound comprising, based in each case on the total weight of the molding compound, A)>38.2% by weight to 99.98% by weight of a thermoplastic polymer or a mixture of thermoplastic polymers, B) 0.01% by weight to <0.8% by weight of titanium dioxide particles having an average primary particle size in the range from 0.5 nm to 25 nm, C) 0.01% by weight to 1.0% by weight of one or more soluble dyes having an absorption in the NIR region that enables the partial transmittance of NIR radiation by the first molded part, and D) 0% to 60% by weight of further admixtures. The invention further relates to methods of producing the shaped body and to the use of a molding compound as a molded part having a laser inscription in the production of a shaped body.

The present invention relates to shaped bodies comprising at least a first molded part and a second molded part, where the first molded part is at least partly transparent to NIR radiation, the second molded part absorbs NIR radiation such that the first molded part and the second molded part are at least partly joined to one another by laser transmission welding, where the first molded part has at least one subregion which is dark-colored and where at least a portion of the subregion has a light-colored laser inscription, where the first molded part consists at least partly of a molding compound comprising, based in each case on the total weight of the molding compound, A)>38.2% by weight to 99.98% by weight of a thermoplastic polymer or a mixture of thermoplastic polymers, B) 0.01% by weight to <0.8% by weight of titanium dioxide particles having an average primary particle size in the range from 0.5 nm to 25 nm, C) 0.01% by weight to 1.0% by weight of one or more soluble dyes having an absorption in the NIR region that enables the partial transmittance of NIR radiation by the first molded part, and D) 0% to 60% by weight of further admixtures. The invention further relates to methods of producing the shaped body and to the use of a molding compound as a molded part having a laser inscription in the production of a shaped body.

Shaped plastic bodies that serve, for example, as covers in the automotive sector, in electrical appliances, as decorative strips or outer claddings frequently themselves consist of different molded parts that have to be permanently bonded to one another.

There exist various methods for the welding of molded plastic parts (Kunststoffe 87, (1997), 11, 1632-1640). A commonly used method of permanent bonding of molded parts is laser welding or laser transmission welding. A prerequisite for the use of laser transmission welding is that the radiation emitted by the laser first penetrates a first molded part having sufficient transparency for laser light of the wavelength used, and is then absorbed by a second molded part, for example in a thin layer which is in contact with the first molded part. The contact region melted in this way then solidifies, so as to enable a permanent bond of the two adherends, i.e. first and second molded parts. Lasers used here are typically those that emit in the near-IR (NIR) region. Accordingly, the first molded part may also be referred to as “NIR-transparent adherend”, and the second molded part as “NIR-absorbing adherend”.

In addition, it is possible to inscribe molded parts by laser. It is possible here, for example, to inscribe the adherend which is likewise responsible for the bonding of the molded parts by laser welding. Depending on the color of the molded part, for generation of a contrast by the laser inscription, it is necessary to create an opposing color appearance. Frequently, the molded part responsible for the welding is dark-colored in order to assure absorption of the NIR radiation for generation of heat. In that case, a light-colored script must be generated by laser inscription. NIR laser radiation is frequently used for this purpose as well (e.g. 1064 mm), but there are also inscription lasers in common use that work in the visible (e.g. 532 nm) or UV region (e.g. 355 nm).

However, there is no satisfactory solution disclosed in the prior art when the “NIR-transparent” adherend is dark-colored and is nevertheless firstly to have a (light-colored) laser inscription and is secondly to be welded to a further adherend.

WO 2020/118059 A1 describes polyester molding compounds comprising two soluble anthraquinone dyes and titanium dioxide. The problem addressed by the patent is that of providing molding compounds from which packings for light-sensitive goods can be produced. The aim is minimum transmittance (less than 1%) of light in the UV-VIS region (190 to 750 nm) even in the case of low wall thicknesses (0.5 mm). In the NIR region at 850 nm, very low transmittance values (2.5%) are still found. No statements are made as to the primary particle size of the titanium dioxide. There is no disclosure of use of the molding compounds as NIR-transparent component in laser transmission welding processes, nor are there any details of laser inscribability in the patent.

CN107163515 A describes light-colored or colorless polyester molding compounds that can be bonded by laser transmission welding. The absorbing adherend comprises NIR absorbers having low intrinsic color. The intention is to provide NIR-transparent adherends with elevated NIR transparency. The increase in NIR transparency is achieved by adding surface-modified titanium dioxide and zinc oxide particles, and with the aid of an alcohol of low molecular weight. The oxide particles have a size of 30 to 400 nm. There are no details in the patent as to laser inscribability.

WO 2006/042623 A1 describes NIR-transparent molding compounds to which “laser-scattering absorbers” or “laser-scattering additives” can be added. Laser-scattering additives mentioned are TiO₂, CaCO₃, MgCO₃ and glass beads. In the examples, the addition of laser-scattering absorbers leads to elevated absorption in the transparent adherend and accordingly to lower transmittance.

WO 2009/066232 A1 describes NIR-absorbing molding compounds that can be used in laser welding processes. Various pigments are used to reduce NIR transmittance in plastics, including TiO₂ pigments having average particle sizes of 30 nm to 4.35 μm. There is no specific description of laser-transparent molding compounds.

There is therefore a need for shaped bodies, NIR-transparent molded parts and molding compounds for such NIR-transparent molded parts, and corresponding methods in which the “NIR-transparent” adherend is dark-colored and can nevertheless firstly have a laser inscription and can secondly be welded to a further adherend.

It is thus an object of the present invention to provide such shaped bodies, NIR-transparent molded parts and molding compounds for such NIR-transparent molded parts.

The object is achieved by a shaped body comprising at least a first molded part and a second molded part, where the first molded part is at least partly transparent to NIR radiation, the second molded part absorbs NIR radiation such that the first molded part and the second molded part are at least partly joined to one another by laser transmission welding, where the first molded part has at least one subregion which is dark-colored and where at least a portion of the subregion has a light-colored laser inscription, where the first molded part consists at least partly of a molding compound comprising, based in each case on the total weight of the molding compound,
A)>38.2% by weight to 99.98% by weight of a thermoplastic polymer or a mixture of thermoplastic polymers,
B) 0.01% by weight to <0.8% by weight of titanium dioxide particles having an average primary particle size in the range from 0.5 nm to 25 nm,
C) 0.01% by weight to 1.0% by weight of one or more soluble dyes having an absorption in the NIR region that enables the partial transmittance of NIR radiation by the first molded part, and
D) 0% to 60% by weight of further admixtures.

The object is also achieved by a method of producing a shaped body of the invention, comprising the steps of
a) bonding the first molded part to the second molded part by laser transmission welding in the NIR region;
b) inscribing the first molded part by laser inscription, especially in the UV/VIS region, where step b) precedes or follows step a), and preferably follows step a).

The object is also achieved by the use of a molding compound described herein as a molded part having a laser inscription in the production of a shaped body.

It has been found that, surprisingly, it is possible through the use of a molding compound comprising titanium dioxide particles of particular primary particle size and soluble dyes to provide an NIR-transparent adherend which is dark-colored, laser-inscribable and weldable.

The molding compound of the invention comprises at least a first and a second molded part. The shaped body itself may assume a wide variety of different forms and correspondingly be used in various ways. The shaped body may essentially extend in only one dimension, as is the case for filaments. Another possibility is an essentially two-dimensional extent, as in the case of films. Typically, however, the shaped body is a three-dimensional body, especially a component that can be used, for example, as a cover in the automotive sector, in electrical appliances, as decorative strip or outer cladding.

The shaped body of the invention may consist solely of the two (first and second) molded parts (adherends) or include further molded parts. This is dependent on the end use in particular.

The first and second adherends are bonded to one another, the bond having been created with the aid of the laser transmission welding method. The two adherends need not be welded completely to one another. Accordingly, it is sufficient that they are partly welded. The welded region here may be dotted (weld point), linear (weld seam) or two-dimensional (weld area).

Laser transmission welding (also referred to as laser beam welding or laser welding for short) is known in the prior art. In laser transmission welding is especially with laser light in the NIR region. Fundamental principles of laser transmission welding are described in the technical literature (see, for example, Kunststoffe 87, (1997) 3, 348-350; Kunststoffe 88, (1998), 2, 210-212; Kunststoffe 87 (1997) 11, 1632-1640; Plastverarbeiter 50 (1999) 4, 18-19; Plastverarbeiter 46 (1995) 9, 42-46).

It is a prerequisite for the use of laser beam welding that the radiation emitted by the laser first penetrates a molded part having sufficient transparency to laser light of the NIR wavelength used (also referred to as NIR-transparent molded part). The wavelength is preferably in the range from 800 nm to 1200 nm.

Transparency is sufficient when the first molded part is at least partly transparent to NIR radiation. The effect of this is that the NIR radiation hits the second molded part to a sufficient degree to enable laser welding. The first molded part preferably at least partly has transmittance for NIR radiation of at least 10%. What is meant here by “at least partly” is that the stated transmittance arises at least in the region corresponding to the welding region. Outside this welding region, the stated transmittance of at least 10% is not required. Preferably, however, the entire first molded part has a transmittance of at least 10%.

The NIR radiation that penetrates the first molded part ultimately hits the welding region, in which it is absorbed in a thin layer of the second molded part which is in contact with the NIR-transparent molded part (NIR-absorbing molded part). In the thin layer that absorbs the NIR laser light, the laser energy is converted to heat, which leads to melting in the welding region and ultimately to bonding of the NIR-transparent and the NIR-absorbing molded part.

Lasers used for laser transmission welding are customarily those in the wavelength range from 800 to 1200 nm. In the wavelength range of the lasers used for thermoplastic welding, Nd:YAG lasers (1064 nm) or high-powered diode lasers (800-1000 nm) are customary.

A multitude of laser welding method variants are available, all of which are based on the principle of transmission. For instance, contour welding is a sequential welding process in which either the laser beam is directed along a freely programmable seam contour or the component is moved relative to the fixedly installed laser. In simultaneous welding, the radiation emitted in a linear manner from individual high-powered diodes is arranged along the seam contour to be welded. The melting and welding of the entire contour are thus simultaneous. Quasi-simultaneous welding is a combination of contour welding and simultaneous welding. The laser beam is run along the weld seam contour with the aid of galvanometric mirrors (scanners) at a very high velocity of 10 m/s or more. The high velocity results in gradual heating and melting of the joining region. Compared to simultaneous welding, there is high flexibility in the event of changes in the weld seam contour. Mask welding is a method in which a linear laser beam is moved transversely across the parts to be joined. A mask is used to selectively shadow the radiation, and it hits the joining surface only where welding is intended. The method permits the production of very exactly positioned weld seams. These methods are known to the person skilled in the art and are described, for example, in “Handbuch Kunststoff-Verbindungstechnik” [Handbook of Plastic Bonding Technology] (G. W. Ehrenstein, Hanser, ISBN 3-446-22668-0) and/or DVS-Richtlinie 2243 “Laserstrahlschweißen thermoplastischer Kunststoffe” [DVS Guideline 2243 “Laser welding of thermoplastics”].

Even though the NIR transparencies of the different thermoplastics can be different, the standard thermoplastics do have sufficiently high transparency in the NIR region, such that laser welding processes are implementable if suitable process parameters are chosen (thickness of the NIR-transparent adherend, intensity of the laser beam, speed of the welding process, etc.).

Because of the low NIR absorption of the thermoplastics, the adherend which is to absorb the laser light is typically equipped with an NIR-absorbing admixture. Suitable for this purpose in particular are pigments having maximum absorption in the wavelength range of the welding laser. The use of all kinds of carbon blacks as NIR-absorbing pigments is particularly suitable and widespread. Therefore, the NIR-absorbing adherends are frequently dark to black in color.

If the NIR-transparent adherend is to have a similar color to the NIR-absorbing adherend, it should be ensured that the color of the NIR-transparent adherend is in particular within the wavelength range perceptible to the human eye (about 380 to 750 nm) and minimum impairment of NIR transmittance takes place.

There are in principle two types of colorants available for coloring of plastics: pigments and soluble dyes (in some cases also referred to simply as “dyes”). Coloring of the NIR-transparent adherend with pigments is not the subject of the invention, since standard pigments have average particle sizes in the range from 0.5 to 4 μm, which scatter NIR light and hence lower NIR transmittance and are unfavorable for the laser welding process. Carbon blacks have a particularly unfavorable effect on NIR transmittance since they greatly lower NIR transmittance by absorption even in very small amounts.

Scattering of NIR light at colorants can be largely avoided when soluble dyes are used since they can be distributed in the thermoplastic to the extent of molecular dispersion and hence do not constitute a source of scattering for NIR light. In addition, the NIR absorption of the soluble dyes should be at a minimum.

In the context of present invention, the shaped body of the invention includes at least the first molded part and the second molded part. As already detailed above, the first molded part is at least partly transparent to NIR radiation in order to enable laser welding. The second molded part absorbs NIR radiation in such a way that the first molded part and the second molded part are at least partly bonded to one another by laser transmission welding. The requisite absorption capacity for NIR radiation can be effected, for example, by adding pigments, such as carbon black.

The first molded part additionally has at least one subregion which is dark-colored, and where at least part of the subregion has a light-colored laser inscription. The terms “dark” and “light” here mean the possibility of distinction between the laser inscription and the subregion of the first molded part that bears the inscription, and the inscription is lighter. The first molded part need not be completely dark-colored, but rather only the subregion that bears the inscription. This subregion is typically not covered completely by an inscription, but rather a portion of the subregion is occupied. It is obvious in the context of the present invention that the dark-colored subregion is chosen such that it is penetrable by NIR radiation in order to enable laser welding, and secondly serves for laser inscription.

Although it is not obligatory, it is preferable that the entire first molded part is dark colored. Preferably, the subregion of the first molded part that has a light-colored laser inscription has a background luminance of at most 50 cd/m², preferably of at most 30 cd/m². Further preferably, the contrast value between background luminance of the subregion of the first molded part that has a light-colored laser inscription and luminance of the laser inscription is at least 80%.

In the context of the present invention, the term “laser inscription” does not mean inscription with letters in the narrower sense, but rather labeling in a wide variety of ways, for example the use of letters, numbers, special characters, barcodes and QR codes, pictograms or the like.

The method of laser inscribability of shaped plastic bodies is known in the prior art. Laser inscription is a rapid and contactless method for applying visually recognizable inscriptions to plastic parts. These may be (machine-)readable inscriptions. Machine-readable inscriptions are, for example, barcodes, QR codes or data matrix codes. Such codes are frequently used to comprise important information characterizing an inscribed plastic part (e.g. manufacturer, manufacturing date, type number, batch number, etc.). In modern production processes, the machine reading of such codes has to be reliable, and there are therefore standard test methods to assess the quality of a code (e.g. ISO IEC 15/TR29158). An important criterion is the contrast (difference in brightness) between inscription and background. Depending on the color of the plastic, it is possible to distinguish between two inscription cases by which high contrast values can be achieved:

$$Plastic color = light and text color = dark ( i . e . color change by the laser from light to dark ) . \qquad 1$$

$$Plastic color = dark and text color = light ( i . e . color change by the laser from dark to light ) . \qquad 2$$

A color change from light to dark (not within the scope of the present invention) can be effected by carbonizing, for example, and from dark to light, for example, by bleaching or foaming. The basic mechanisms are described in the technical literature, for example Kunststoffe 2006/10 p.199-203, Kunststoffe 2009/06 p.66-69 or Journal of Materials Processing Technology 1994/42 p.95-133.

Commercially available inscription systems work with laser light from the UV into the IR region. Nd:YAG and Nd:YVO4 lasers are widely used, as are inscription wavelengths of 1064, 532 and 355 nm.

In the context of the present invention, it is preferable when laser inscription is accomplished using laser radiation in the UV/VIS region (<800 nm, preferably 100 nm to 780 nm, especially in the UV region from 100 nm to 380 nm).

In order that a good inscription contrast and a uniform, finely resolved inscription can be achieved, the plastic to be inscribed must at least partly absorb the light from the laser. Since the vast majority of plastics absorb barely any light in the region of the wavelengths mentioned, they have to be admixed with additives that assume this function. In the visible region, these may be colorants, whereas absorbers for the UV and NIR region may also appear colorless. It has in many cases been found to be advantageous when the absorbers are of the pigment type and are not in dissolved form in the plastic (by contrast with the abovementioned soluble dyes). All kinds of carbon blacks are such pigment-type absorbers and are of good suitability for the entire range from UV to NIR.

When two shaped plastic bodies are bonded to one another by laser transmission welding, one of the adherends is NIR-absorbing, as described above. In principle, it is therefore readily possible to apply a laser inscription on the NIR-absorbing adherend, for example with a 1064 nm inscription laser. For reasons of lack of space or unfavourable component geometries, it is advantageous not to apply the laser inscription on the NIR-absorbing adherend. It may then be necessary to undertake the laser inscription on the NIR-transparent adherend, as is the case in the context of the present invention.

The first molded part consists at least partly of a molding compound comprising, based in each case on the total weight of the molding compound,
A)>38.2% by weight to 99.98% by weight of a thermoplastic polymer or a mixture of thermoplastic polymers,
B) 0.01% by weight to <0.8% by weight of titanium dioxide particles having an average primary particle size in the range from 0.5 nm to 25 nm,
C) 0.01% by weight to 1.0% by weight of one or more soluble dyes having an absorption in the NIR region that enables the partial transmittance of NIR radiation by the first molded part, and
D) 0% to 60% by weight of further admixtures.

Advantageously, the first molded part is formed exclusively from the molding compound. This comprises components A) to D). It preferably consists of these components. In this context, component D) is not mandatorily present (0%); preferably, component D) is present, for example at at least 0.01% by weight based on the total weight of the molding compound. The molding compound, based in each case on the total weight of the molding compound, preferably comprises 43.8% by weight to 89.96% by weight of A), 0.02% by weight to 0.65% by weight of B, 0.02% by weight to 0.55% by weight of C, and 10% by weight to 55% by weight of D. The molding compound, based in each case on the total weight of the molding compound, more preferably comprises 44.1% by weight to 89.9% by weight of A), 0.05% by weight to 0.35% by weight of B, 0.05% by weight to 0.55% by weight of C, and 10% by weight to 55% by weight of D.

As component A), the molding compound comprises a thermoplastic polymer or a mixture of thermoplastic polymers. Suitable thermoplastic polymers are, for example, polyethene (PE), polypropene (PP), polystyrene (PS), styrene copolymers (SAN, ASA), polyvinylchloride (PVC), polyamides (PA), polyester (PES), polycarbonates (PC), polyphenylene sulfide (PPS) and polyacrylates. It is also possible to use mixtures of two or more of these polymers of one kind (for example two different PE polymers) or of different kinds (for example one PE and one PP).

### Polyesters

Preference is given to the following polyesters and mixtures thereof (names according to DIN EN ISO 1043-1):
polybutylene terephthalate (PBT)
polyethylene terephthalate (PET)
polytrimethylene terephthalate (PTT)
polycyclohexylene dimethylene terephthalate (PCT)
polyethylene naphthalate (PEN)
polybutylene naphthalate (PBN)
polybutylene succinate (PBS)
polybutylene succinate adipate (PBSA)
polycyclohexylene dimethylene cyclohexanedicarboxylate (PCCE)
polyethylene succinate (PES)
polyhydroxyalkanoate (PHA)
poly(3-hydroxybutyrate) (PHB)
polycaprolactone (PCL)

As well as the eponymous structural units, it is also possible for small amounts of further structural units that can be derived from other diols and/or dicarboxylic acids to occur in the respective polymers.

Examples of further diols are:
ethane-1,2-diol, propane-1,3-diol, butane-1,4-diol, hexane-1,6-diol, hexane-1,4-diol, cyclohexane-1,4-diol, cyclohexane-1,4-dimethanol and neopentyl glycol, or mixtures thereof.

Examples of further dicarboxylic acids are:
terephthalic acid, isophthalic acid, naphthalene-2,6-dicarboxylic acid, furan-2,5-dicarboxylic acid, adipic acid, azelaic acid, sebacic acid, dodecanedioic acids and cyclohexanedicarboxylic acids.

The proportion of further monomers based on the respective main components is preferably <20 mol %, more preferably <10 mol %.

As well as the (predominant) homopolymers that can be derived mainly from a dicarboxylic and a diol, preference is also given to copolymers in which relatively large amounts of structural units that can be derived from two or more diols and/or dicarboxylic acids occur.

Particular preference is given to polybutylene terephthalate (PBT) and polyethylene terephthalate (PET), and mixtures thereof.

PBT can be prepared by polycondensation from butane-1,4-diol (BDO) and terephthalic acid, forming not only PBT but also water. The polycondensation is usually commenced with an excess of BDO. The excess BDO is then separated off together with the water, such that BDO and terephthalic acid are ultimately present in the PBT again approximately in a molar ratio of 1:1. Through the choice of process conditions, it is possible to adjust both the average molar mass and the ratio of alcohol and acid end groups as required.

Most commercial PBT polymers comprise more alcohol end groups than acid end groups. Preference is given to polyesters wherein the acid end group content is <100 mmol/kg, preferably <50 mmol/kg and especially <40 mmol/kg.

The progress of the polycondensation reaction is typically accelerated by addition of catalysts. Standard catalysts are alkyl orthotitanates. These catalysts remain largely in the polymer, partly in hydrolyzed form. Therefore, in commercial PBT polymers, it is usually possible to analytically detect a titanium content of 20 to 200 ppm. A residual titanium content of <150 ppm is preferred. Residues of titanium-based catalysts are inactive for the purposes of the present invention.

The preparation of PBT from BDO and dimethyl terephthalate (DMT) can be effected analogously. In that case, methanol rather than water is formed as condensation product alongside PBT.

The viscosity number of PBT is generally in the range from 50 to 220 cm³/g, preferably from 80 to 160 cm³/g (measured in a 0.5% by weight solution in a phenol/o-dichlorobenzene mixture (weight ratio 1:1 at 25° C.) to ISO 1628.

The preparation of PET can be effected similarly from ethylene glycol and terephthalic acid or DMT. An important side reaction in the preparation of PET is the condensation of ethylene glycol to diethylene glycol, which is again a diol compound that can be incorporated into the polymer chain. As a result, commercial PET usually comprises a small proportion (<5 mol %) of diethylene glycol comonomers. As required, further comonomers are also added in the preparation of PET in order to adjust the melting and solidification characteristics to the requirements of the respective processing methods or applications. Examples of comonomers are diethylene glycol, isophthalic acid and cyclohexane-1,4-dimethanol.

An introduction to polyester production is given, for example, by the “Kunststoff Handbuch 3/1-Polycarbonate, Polyacetale, Polyester, Celluloseester” [Plastics Handbook 3/1-Polycarbonates, Polyacetals, Polyesters, Cellulose esters), ed. L. Bottenbruch, Carl Hanser Verlag 1992, page 12 ff. An overview of PET polymers is given, for example, by the market study “Polyethylene Terephthalate, PERP 2017-2” from Nexant.

### Polyamides

Preference is given to semicrystalline or amorphous resins with a molecular weight (Mw) of at least 5000, as described, for example, in U.S. Pat. Nos. 2,071,250, 2,071,251, 2,130,523, 2,130,948, 2,241,322, 2,312,966, 2,512,606 and 3,393,210.

Examples thereof are polyamides which derive from lactams having 7 to 13 ring members, such as polycaprolactam, polycaprylolactam and polylaurolactam, and also polyamides obtained by reaction of dicarboxylic acids with diamines.

Usable dicarboxylic acids include alkanedicarboxylic acids having 6 to 12 carbon atoms, in particular 6 to 10 carbon atoms, and aromatic dicarboxylic acids. Acids that shall be mentioned here are solely adipic acid, azelaic acid, sebacic acid, dodecanedioic acid and terephthalic and/or isophthalic acid.

Particularly suitable diamines include alkanediamines having 6 to 12, in particular 6 to 8, carbon atoms and m-xylylenediamine, di(4-aminophenyl)methane, di(4-aminocyclohexyl)methane, 2,2-di(4-aminophenyl)propane, 2,2-di(4-aminocyclohexyl)propane or 1,5-diamino-2-methylpentane.

Preferred polyamides are polyhexamethyleneadipamide, polyhexamethylenesebacamide and polycaprolactam, and also 6/66 copolyamides, in particular having a proportion of 5% to 95% by weight of caprolactam units (for example Ultramid® C31 from BASF SE). Suitable polyamides further include those obtainable from w-aminoalkyl nitriles, for example aminocapronitrile (PA 6) and adipodinitrile with hexamethylenediamine (PA 66) by what is called direct polymerization in the presence of water, as described for example in DE-A 10313681, EP-A 1 198491 and EP 922065.

In addition, polyamides that shall also be mentioned include those obtainable, for example, by condensing 4-diaminobutane with adipic acid at elevated temperature (nylon-4,6). Production processes for polyamides having this structure are described for example in EP-A 38 094, EP-A 38 582 and EP-A 39 524.

Also suitable are polyamides obtainable by copolymerization of two or more of the abovementioned monomers or mixtures of a plurality of polyamides in any desired mixing ratio. Particular preference is given to mixtures of nylon-6,6 with other polyamides, in particular nylon-6/6,6 copolyamides.

Furthermore, semiaromatic copolyamides such as PA 6/6T and PA 66/6T have been found to be particularly advantageous when their triamine content is less than 0.5% by weight, preferably less than 0.3% by weight (see EP-A 299 444). Further high-temperature-resistant polyamides are known from EP-A 19 94 075 (PA 6T/6I/MXD6).

The production of the preferred semiaromatic copolyamides having a low triamine content can be carried out by the processes described in EP-A 129 195 and 129 196.

The following nonexhaustive list comprises the recited polyamides and other polyamides A) in the context of the invention, and the monomers present.

AB polymers:

| | |
|---|---|
| PA 4 | pyrrolidone |
| PA 6 | ε -caprolactam |
| PA 7 | ethanolactam |
| PA 8 | caprylolactam |
| PA 9 | 9-aminopelargonic acid |
| PA 11 | 11-aminoundecanoic acid |
| PA 12 | laurolactam |

AA/BB polymers

| | |
|---|---|
| PA 46 | tetramethylenediamine, adipic acid |
| PA 66 | hexamethylenediamine, adipic acid |
| PA 69 | hexamethylenediamine, azelaic acid |
| PA 610 | hexamethylenediamine, sebacic acid |
| PA 612 | hexamethylenediamine, decanedicarboxylic acid |
| PA 613 | hexamethylenediamine, undecanedicarboxylic acid |
| PA 1212 | dodecane-1,12-diamine, decanedicarboxylic acid |
| PA 1313 | 1,13-diaminotridecane, undecanedicarboxylic acid A |
| PA 6T | hexamethylenediamine, terephthalic acid |
| PA 9T | nonane-1,9-diamine, terephthalic acid |
| PA MXD6 | m-xylylenediamine, adipic acid |
| PA 6I | hexamethylenediamine, isophthalic acid |
| PA 6-3-T | trimethylhexamethylenediamine, terephthalic acid |
| PA 6/6T | (see PA 6 and PA 6T) |
| PA 6/66 | (see PA 6 and PA 66) |
| PA 6/12 | (see PA 6 and PA 12) |
| PA 66/6/610 | (see PA 66, PA 6 and PA 610) |
| PA 6I/6T | (see PA 61 and PA 6T) |
| PA PACM 12 | diaminodicyclohexylmethane, laurolactam |
| PA 6I/6T/PACM | as PA 6I/6T + diaminodicyclohexylmethane |
| PA 12/MACMI | laurolactam, dimethyldiaminodicyclohexylmethane, |
| | isophthalic acid |
| PA 12/MACMT | laurolactam, dimethyldiaminodicyclohexylmethane, |
| | terephthalic acid |
| PA PDA-T | phenylenediamine, terephthalic acid |

Commercially available polymers of any kind are usually supplied in particular viscosities. A mixture of polymers that differ essentially only by their viscosity can be made at any time if, for example, an “average” viscosity is to be established.

The thermoplastic polymer is preferably a polyester or a polyamide, more preferably a polyester, or a mixture of two or more of these thermoplastic polymers. A preferred ester is polybutylene terephthalate (PBT). Accordingly, in a preferred embodiment of the present invention, the thermoplastic polymer is PBT or a mixture of thermoplastic polymers having at least 45% by weight, preferably at least 60% by weight, of PBT based on the total weight of A).

The second molded part preferably also includes the above-described thermoplastics or mixtures thereof.

As component B), the molding compound comprises titanium dioxide particles having an average primary particle size in the range from 0.5 nm to 25 nm. The titanium dioxide particles preferably have an average primary particle size in the range from 5 nm to 25 nm, more preferably from 10 nm to 25 nm. The average particle size can be determined, for example, according to DIN ISO 9276-2 (2018-09). The titanium dioxide particles may be coated or uncoated.

As component C), the molding compound includes one or more soluble dyes having an absorption in the NIR region that enables the partial transmittance of NIR radiation by the first molded part. Suitable dyes are known to the person skilled in the art and may, for example, be of the pyrazolone, perinone, anthraquinone, methine, azo, anthrapyridone or coumarin type, and are described, for example, in WO 02057353, EP 1258506, EP 1353986, EP 1353991, EP 1582565, EP 1797145, EP 1847375, EP 3421540, JP 4176986 or JP 4073202.

The term “soluble” in the context of the present invention is understood to mean that the dye may be soluble in the liquid phase of the molding compound, such that a molecularly disperse distribution is possible. Accordingly, soluble dyes may be pyrazolone, perinone, anthraquinone, methine, azo, anthrapyridone or coumarin dyes.

Illustrative soluble dyes that are commercially available are described by the “Solvent” color index class. Examples are anthraquinone dyes, such as CI Solvent Green 3, or a perinone dye, such as CI Solvent Red 179.

If the NIR-transparent adherend is to take on a black or dark gray color, it is also possible to combine two or more soluble chromatic dyes such that the absorption of the dye mixture extends over the entire visible region.

In addition, the molding compound may comprise admixtures. These are dependent on the field of use of the shaped body. Illustrative admixtures (additives) are flame retardants, for example phosphorus compounds, organic halogen compounds, nitrogen compounds and/or magnesium hydroxide, stabilizers, processing auxiliaries, for example lubricants/mold release agents, nucleating agents, hydrolysis stabilizers, impact modifiers, for example rubbers or polyolefins and the like, provided that these do not have excessive absorption in the region of the wavelength of the welding laser used.

Useful fibrous reinforcers, as well as glass fibers, are aramid fibers, mineral fibers and whiskers. Suitable mineral fillers include, by way of example, calcium carbonate, dolomite, calcium sulfate, mica, fluoromica, wollastonite, talc and kaolin. Glass beads (solid or hollow) may likewise be used. In order to improve mechanical properties, the fibrous reinforcers and the mineral fillers may have been surface-treated.

The molding compound preferably comprises glass fibers as a constituent of component D). The proportion of glass fibers is preferably 10% by weight to 50% by weight based on the total weight of the molding compound.

It is also possible for hydrolysis stabilizers to be present in the molding compound. A suitable proportion is 1% by weight to 5% by weight based on the total weight of the molding compound.

Suitable hydrolysis stabilizers are epoxidized vegetable oils. Vegetable oils of good suitability have a high proportion of mono- and/or polyunsaturated fatty acids since it is then possible to achieve a high specific epoxide content. Derivatives of such vegetable oils that can be obtained by transesterification with other mono- or polyhydric alcohols can likewise be epoxidized and can likewise be used as hydrolysis stabilizers. Examples are epoxidized linseed oil, oxidized soybean oil or epoxidized fatty acid methyl esters based on linseed oil or soybean oil. Such compounds are produced on an industrial scale and find use as plasticizers for PVC or as raw materials for paints and polymers. A summary of industrially important epoxides and the manufacturers thereof can be found, for example, in “IHS Chemical Process Economics Program, Report 62B, 2014, Eco-Friendly Plasticizers”.

Further suitable hydrolysis stabilizers are epoxy resins made from bisphenol A and epichlorohydrin that have terminal epoxy groups. Such epoxy resins are in use as raw materials for paints and coatings and may have an average molecular weight of a few hundred to a few thousand g/mol.

Further suitable hydrolysis stabilizers are monomeric, oligomeric or polymeric carbodiimides.

The present invention further provides a method of producing a shaped body of the invention, comprising the steps of
a) bonding the first molded part to the second molded part by laser transmission welding in the NIR region;
b) inscribing the first molded part by laser inscription, preferably in the UV/VIS region, where step b) precedes or follows step a), and preferably follows step a).

Both the joining by laser transmission methods in step a) and the laser inscription in step b) have been elucidated in detail above and are familiar to the person skilled in the art.

The present invention likewise further provides for the use of a molding compound as described above as a molded part having a laser inscription in the production of a shaped body, especially a shaped body of the invention.

### EXAMPLES

### Raw Materials

PBT polymer:
A) Ultradur® B2550 natur. The product has the following properties:
Viscosity number (to ISO 1628, in phenol/1,2-dichlorobenzene (1:1) at 25° C.): 108 cm³/g
Acidic end groups (by alkalimetric titration): 22 mmol/kg
Titanium content (by x-ray fluorescence measurement): 102 ppm

### Glass Fibers:

B) DS 3185 E-10N from 3B: E glass glass fibers, average diameter of about 10 μm with size for polyester. Glass fiber sizes are usually complex formulations and comprise a treatment with silanes, film formers and further additives. Extensive examples can be found, for example, in EP 2 540 683 A1, EP 2 554 594 A1, or EP 1993 966 B1. Scientific literature in this regard can be found, for example, in “Glass Fibre Sizings” by J. L. Thomason (ISBN 978-0-9573814-1-4).

### Mold Release Agents:

C) Loxiol P 861/3.5 from Emery Oleochemicals: fatty acid esters with pentaerythritol.

### Hydrolysis Stabilizers:

D1) Vikoflex 7190 from Arkema: epoxidized linseed oil, oxirane oxygen about 9.5 w %
D2) ARALDITE GT 7077 from Jana: epoxy resin based on bisphenol A and epichlorohydrin, oxirane oxygen about 1 w %
   Dyes (from the “Solvent” Color Index Class):
E1) CI Solvent Green 3, e.g. Macrolex Grün 5B from RheinChemie
E2) CI Solvent Red 179, e.g. Macrolex Rot E2G from RheinChemie

### Titanium Dioxide Pigments:

F1) Hombitec RM 230 L (from Venator), ultrafine TiO2 particles with inorganic (Al- and Ce-based) and organic (stearic acid) surface treatment; average primary particle size about 20 nm.
F2) Hombitec RM 130 F (from Venator), ultrafine TiO2 particles with inorganic (Al-based) and organic (stearic acid) surface treatment; average primary particle size about 15 nm.
F3) TiO2 F-RC5 (from Venator), TiO2 particles with inorganic (Al-based) and organic surface treatment (silicone and others); average primary particle size about 190 nm.
F4) Kronos 2220 (from Kronos), TiO2 particles with inorganic (Al- and Si-based) and organic surface treatment (silicone). Primary particle size about 300-400 nm.

### Tests

### Tensile Test to ISO 527 on Type 1A Specimens

UV-VIS-NIR transmission: 2 mm-thick injection-molded plaques are analyzed with a laboratory photometer with Ulbricht sphere.

### Laser Inscription:

2 mm-thick injection-molded plaques were inscribed with a commercial inscribing system (Trumpf TruMark 6330, Nd:YV04 laser, wavelength 355 nm). The operating current and scanner frequency of the laser beam were varied in order to obtain an optimal inscription outcome (maximum contrast value). The optimal inscription outcome was used for measurement of luminance.

### Luminance Measurement:

The brightness of the laser-inscribed surfaces and of the background was measured with a Minolta LS-110 luminance meter. The luminance values were used to calculate the contrast value by the following formulae:

$$Light background / dark inscription : Contrast = 100 \% * ( luminance of background - luminance of inscription ) / luminance of background \qquad 1 )$$

$$Dark background / light inscription : Contrast = 100 \% * ( luminance of inscription - luminance of background ) / luminance of inscription \qquad 2 )$$

Hydrolytic aging of test specimens in steam at 110° C. for 7 days. The test specimens were used for tensile testing without prior drying (only in the case of compositions comprising hydrolysis stabilizers).

### Production of the Compounds

All the compounds were produced with a twin-shaft extruder (shaft diameter 25 mm). The following processing parameters were chosen: speed 200 rpm, throughput 14 kg/h, temperature 270° C. Glass fibers and Vikoflex 7910 were metered directly into the melt; all other raw materials (PBT and other additives) were metered in via the intake.

### Results

TABLE 1

| | Compositions [w %] | | | |
|---|---|---|---|---|
| | A | B | C | D |
| | Comp. 1 | Ex. 1 | Comp. 2 | Comp. 3 |
| A) PBT (component A) | 69.4 | 69.2 | 69.2 | 69.2 |
| B) Glass fibers (component D) | 30 | 30 | 30 | 30 |
| C) Mold release agents (component D) | 0.4 | 0.4 | 0.4 | 0.4 |
| D1) Epoxidized linseed oil (component D) | | | | |
| D2) Epoxy resin (component D) | | | | |
| E1) Solvent Green 3 (component C) | 0.1 | 0.1 | 0.1 | 0.1 |
| E2) Solvent Red 179 (component C) | 0.1 | 0.1 | 0.1 | 0.1 |
| F1) Hombitec RM 230 L (component B) | | 0.2 | | |
| F2) Hombitec RM 130 F (component B) | | | | |
| F3) TiO2 F-RC5 (component B′)*) | | | 0.2 | |
| F4) Kronos 2220 (component B′)*) | | | | 0.2 |

Properties

| | | | | |
|---|---|---|---|---|
| Mechanical | | | | |
| Tensile strength unaged [MPa] | 136 | 133 | 112 | 110 |
| Tensile strength after aging [MPa] | | | | |
| Transmittance [%] | | | | |
| 300-700 nm | 0 | 0 | 0 | 0 |
| 800 nm | 18 | 18 | 13 | 12 |
| 900 nm | 19 | 19 | 14 | 13 |
| 1000 nm | 20 | 20 | 15 | 14 |
| 1100 nm | 21 | 21 | 16 | 15 |
| Inscription | | | | |
| Optimal operating current [A] | 85 | 60 | 70 | 70 |
| Optimal scanner frequency [kHz] | 11 | 15 | 19 | 19 |
| Luminance measurement | | | | |
| Inscribed area [cd/m²] | 64 | 115 | 91 | 85 |
| Background [cd/m²] | 19 | 19 | 22 | 21 |
| Contrast value [%] | 70 | 83 | 76 | 75 |

*)average particle size not in accordance with the invention

Compositions A to D show that only titanium dioxide particles that are sufficiently small bring the desired improvements. If the particles are too large (C and D), the tensile strength is distinctly reduced, transmittance values in the NIR region decrease, and the contrast value increases to a lesser degree than from A to B.

TABLE 2

| Compositions | E | F | G | H | I | J | K | L |
|---|---|---|---|---|---|---|---|---|
| [w %] | Comp. 4 | Ex. 2 | Ex. 3 | Ex. 4 | Comp. 5 | Ex. 5 | Ex. 6 | Comp. 6 |
| A) PBT | 67.4 | 67.3 | 67.2 | 66.9 | 66.6 | 67.2 | 66.9 | 66.6 |
| B) Glass fibers | 30 | 30 | 30 | 30 | 30 | 30 | 30 | 30 |
| C) Mold release | 0.4 | 0.4 | 0.4 | 0.4 | 0.4 | 0.4 | 0.4 | 0.4 |
| agents | | | | | | | | |
| D1) Epoxidized | 1.5 | 1.5 | 1.5 | 1.5 | 1.5 | 1.5 | 1.5 | 1.5 |
| linseed oil | | | | | | | | |
| D2) Epoxy resin | 0.5 | 0.5 | 0.5 | 0.5 | 0.5 | 0.5 | 0.5 | 0.5 |
| E1) Solvent Green 3 | 0.1 | 0.1 | 0.1 | 0.1 | 0.1 | 0.1 | 0.1 | 0.1 |
| E2) Solvent Red 179 | 0.1 | 0.1 | 0.1 | 0.1 | 0.1 | 0.1 | 0.1 | 0.1 |
| F1) Hombitec RM 230 L | | 0.1 | 0.2 | 0.5 | 0.8 | | | |
| F2) Hombitec RM 130 F | | | | | | 0.2 | 0.5 | 0.8 |
| F3) TiO2 F-RC5 | | | | | | | | |
| F4) Kronos 2220 | | | | | | | | |
| Properties | | | | | | | | |
| Mechanical | | | | | | | | |
| Tensile strength | 134 | 130 | 131 | 131 | 136 | 131 | 129 | 133 |
| unaged [MPa] | | | | | | | | |
| Tensile strength after | 92 | 89 | 85 | 82 | 49 | 88 | 81 | 37 |
| aging [MPa] | | | | | | | | |
| Transmittance [%] | | | | | | | | |
| 300-700 nm | 0 | 0 | 0 | 0 | 0 | 0 | 0 | 0 |
| 800 nm | 16 | 17 | 17 | 17 | 17 | 17 | 16 | 16 |
| 900 nm | 17 | 17 | 17 | 18 | 18 | 18 | 17 | 18 |
| 1000 nm | 19 | 19 | 19 | 20 | 20 | 20 | 19 | 20 |
| 1100 nm | 21 | 21 | 21 | 21 | 21 | 22 | 21 | 22 |
| Inscription | | | | | | | | |
| Optimal operating | 85 | 60 | 50 | 65 | 50 | 45 | 40 | 40 |
| current [A] | | | | | | | | |
| Optimal scanner | 29 | 17 | 9 | 7 | 7 | 11 | 9 | 11 |
| frequency [kHz] | | | | | | | | |
| Luminance | | | | | | | | |
| measurement | | | | | | | | |
| Inscribed area [cd/m²] | 68 | 125 | 117 | 102 | 91 | 124 | 102 | 91 |
| Background [cd/m²] | 19 | 18 | 18 | 19 | 19 | 19 | 20 | 21 |
| Contrast value [%] | 72 | 86 | 85 | 81 | 79 | 85 | 80 | 77 |

Compositions E to L show that titanium dioxide particles that are appropriately small, even in small amounts, bring the desired improvements in the contrast values without significant impairment of transmittance values in the NIR region. But it is also apparent that titanium dioxide reduces the effectiveness of the hydrolysis stabilizers. This effect is particularly apparent at a titanium dioxide content of 0.8% (not in accordance with the invention).

TABLE 3

Compositions [w %]

| | M | N |
|---|---|---|
| | Comp. 7 | Comp. 8 |
| A) PBT | 69.6 | 69.4 |
| B) Glass fibers | 30 | 30 |
| C) Mold release agents | 0.4 | 0.4 |
| D1) Epoxidized linseed oil | | |
| D2) Epoxy resin | | |
| E1) Solvent Green 3 | | |
| E2) Solvent Red 179 | | |
| F1) Hombitec RM 230 L | | 0.2 |
| F2) Hombitec RM 130 F | | |
| F3) TiO2 F-RC5 | | |
| F4) Kronos 2220 | | |

Properties

| | | |
|---|---|---|
| Mechanical | | |
| Tensile strength unaged [MPa] | 143 | 139 |
| Tensile strength after aging [MPa] | | |
| Transmittance [%] | | |
| 300-700 nm | | |
| 800 nm | | |
| 900 nm | | |
| 1000 nm | | |
| 1100 nm | | |
| Inscription | | |
| Optimal operating current [A] | 95 | 50 |
| Optimal scanner frequency [kHz] | 13 | 7 |
| Luminance measurement | | |
| Inscribed area [cd/m²] | 244 | 153 |
| Background [cd/m²] | 303 | 318 |
| Contrast value [%] | 19 | 52 |

Compositions M to N show that titanium dioxide particles that are appropriately small can also improve the contrast value in the case of uncolored products. However, the contrast value remains low and unsatisfactory.

1. A shaped body comprising at least a first molded part and a second molded part, where the first molded part is at least partly transparent to NIR radiation, the second molded part absorbs NIR radiation such that the first molded part and the second molded part are at least partly joined to one another by laser transmission welding, where the first molded part has at least one subregion which is dark-colored and where at least a portion of the subregion has a light-colored laser inscription, where the first molded part comprises at least partly of a molding compound comprising, based in each case on the total weight of the molding compound,
A) greater than 38.2% by weight to 99.98% by weight of a thermoplastic polymer or a mixture of thermoplastic polymers,
B) 0.01% by weight to less than 0.8% by weight of titanium dioxide particles having an average primary particle size in the range from 0.5 nm to 25 nm,
C) 0.01% by weight to 1.0% by weight of one or more soluble dyes dye having an absorption in the NIR region that enables the partial transmittance of NIR radiation by the first molded part, and
D) 0% to 60% by weight of further admixtures.

2. The shaped body according to claim 1, wherein the molding compound comprises 43.8% by weight to 89.96% by weight of A), 0.02% by weight to 0.65% by weight of B), 0.02% by weight to 0.55% by weight of C), and 10% by weight to 55% by weight of D).

3. The shaped body according to claim 1, wherein the molding compound comprises 44.1% by weight to 89.9% by weight of A), 0.05% by weight to 0.35% by weight of B), 0.05% by weight to 0.55% by weight of C), and 10% by weight to 55% by weight of D).

4. The shaped body according to claim 1, wherein the thermoplastic polymer is a polyester or a polyamide, or a mixture of two or more of these thermoplastic polymers.

5. The shaped body according to claim 1, wherein the thermoplastic polymer is PBT, or the mixture of thermoplastic polymers includes comprising at least 45% by weight, based on the total weight of A), of PBT.

6. The shaped body according to claim 1, wherein the titanium dioxide particles have an average primary particle size in the range from 5 nm to 25 nm.

7. The shaped body according to claim 1, wherein admixtures D) present are present at 10% by weight to 50% by weight, based on the total weight of the molding compound, of glass fibers.

8. The shaped body according to claim 1, wherein admixtures D) present are 1% by weight to 5% by weight, based on the total weight of the molding compound, of hydrolysis stabilizers.

9. The shaped body according to claim 1, wherein the subregion of the first molded part that has a light-colored laser inscription has a background luminance of at most 50 cd/m².

10. The shaped body according to claim 1, wherein a contrast value between a background luminance of the subregion of the first molded part that has a light-colored laser inscription and luminance of the laser inscription is at least 80%.

11. The shaped body according to claim 1, wherein the NIR radiation is in the wavelength range from 800 nm to 1200 nm.

12. The shaped body according to claim 1, wherein the first molded part at least partly has transmittance for NIR radiation of at least 10%.

13. A method of producing a shaped body according to claim 1, comprising
a) bonding the first molded part to the second molded part by laser transmission welding in the NIR region;
b) inscribing the first molded part by laser inscription, where step b) precedes or follows step a).

14. The method according to claim 13, wherein the laser inscription is effected with laser light in the UV/VIS region.

15. (canceled)
